(19) United States
(12) Patent Application Publication
(10) Pub. No.: US 2009/0168822 A1
(43) Pub. Date: Jul. 2, 2009

(54) LASER CONTROL APPARATUS AND ELECTRONIC DEVICE USING THE SAME

(75) Inventors: CHUN-LUNG HUNG, Tu-Cheng (TW); TAO WANG, Shenzhen City (CN); WANG-CHANG DUAN, Shenzhen City (CN); WEN-MING CHEN, Shenzhen City (CN); KUN HUANG, Shenzhen City (CN); JIE LIU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/138,437

(22) Filed: Jun. 13, 2008

(30) Foreign Application Priority Data
Dec. 26, 2007 (CN) 200710203416.3

(51) Int. Cl. H01S 3/00

(52) U.S. Cl. 372/38.03

(57) ABSTRACT

A laser control apparatus includes a detector and a switch module. The detector is for detecting states of a mechanism having a closed state in which the mechanism blocks a laser and an opened state in which the mechanism unblocks the laser. The switch module is for transmitting an emitting command to a laser unit to emit the laser. When the opened state is detected, the switch module stops transmitting the emitting command. An electronic device using the laser control apparatus is also disclosed.

### BACKGROUND

1. Field of the Invention

The present invention generally relates to lasers, and particularly to an electronic device using a laser control apparatus.

2. Description of related art

Laser diodes emit light in narrow, low-divergence monochromatic, beams with well-defined wavelengths. Because of these excellent optical features, lasers are widespread and are used in laser printers, bar code readers, optical storage devices, etc.

However, under some circumstances, the laser diodes are not turned off immediately when the laser is turned off, thus, electronic devices using the laser diodes may waste power or even harm people unintentionally.

Therefore, a laser control apparatus for an electronic device is needed in the industry to address the aforementioned deficiency.

### SUMMARY

A laser control apparatus includes a detector and a switch module. The detector is for detecting states of a mechanism having a closed state in which the mechanism blocks a laser and an opened state in which the mechanism unblocks the laser. The switch module is for transmitting an emitting command to a laser unit to emit the laser. When the opened state is detected, the switch module stops transmitting the emitting command. An electronic device using the laser control apparatus is also disclosed.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic block diagram showing a laser control apparatus controlling a laser unit in accordance with an exemplary embodiment.

FIG. 2 is a circuit diagram showing detailed circuits of the laser control apparatus of FIG. 1.

### DETAILED DESCRIPTION

Reference will now be made to the drawings to describe a preferred embodiment of the present laser control apparatus.

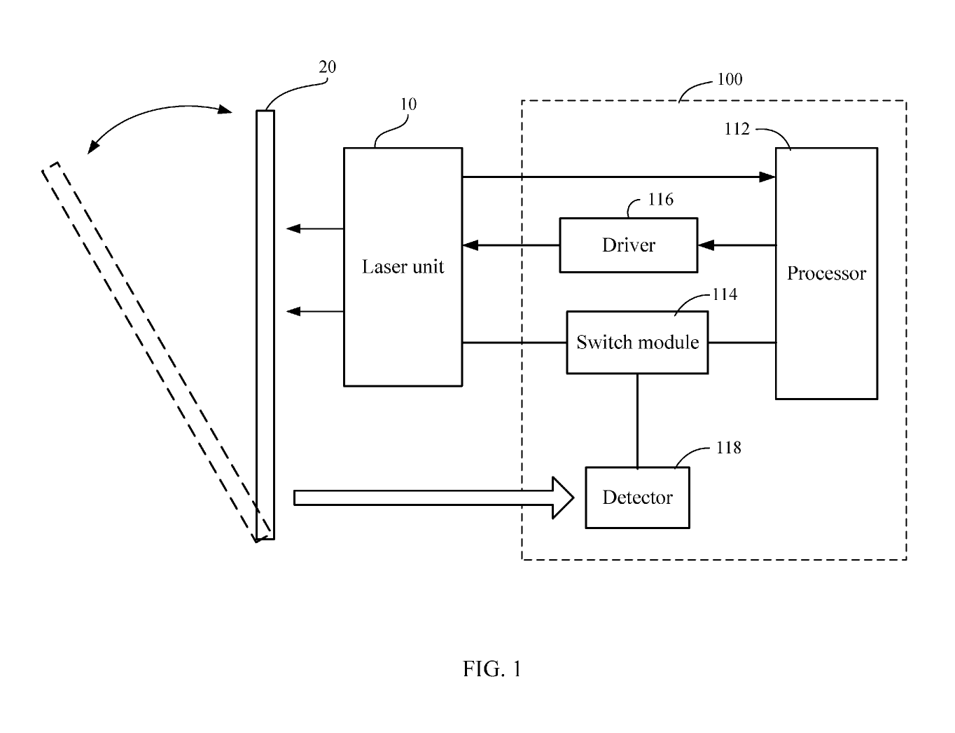

Referring to FIG. 1, a laser control apparatus 100 in accordance with an exemplary embodiment is used to control a laser unit 10 that may be a laser diode or an array of laser diodes. The laser control apparatus 100 is enclosed in a portable digital versatile disc (DVD) player (not shown) to detect operations, such as closing and opening of a cover 20, so as to turn on or off the laser unit 10. When the cover 20 is closed, lasers emitted from the laser unit 10 are blocked by the cover 20. When the cover 20 is opened, the laser unit 10 stops emitting the lasers correspondingly. In other embodiments, the laser control apparatus 100 may be enclosed in a laser printer, a bar code reader, or other electronic devices.

The laser unit 10 is configured for emitting the lasers to perform some functions. In this embodiment, the laser unit 10 is an optical pickup head (OPU) configured for emitting lasers to an optical disc and receiving the lasers reflected from the optical disc to read information from or write information to the optical disc.

The laser control apparatus 100 includes a processor 112, a switch module 114, a driver 116, and a detector 118. The processor 112 transmits emitting commands to the laser unit 10 via the switch module 114, and correspondingly the laser unit 10 emits the lasers. The processor 112 also receives data from the laser unit 10 converted from the information, and generates servo commands based on the data. The switch module 114 controls an electrical connection between the laser unit 10 and the processor 112 based on the detected results of the detector 118. The driver 116 controls movements, such as focusing and tracking, of the laser unit 10 with respect to the optical disc based on the servo commands. The detector 118 detects operations of the cover 20 of the DVD player.

In the embodiment, when a closing operation of the cover 20 is detected, that is, the cover 20 is in a closed state, the detector 118 makes no response. When an opening operation of the cover 20 is detected, that is, the cover 20 is in an opened state, the detector 118 generates an open signal. Based on the open signal, the switch module 14 is turned off, and opens the electrical connection.

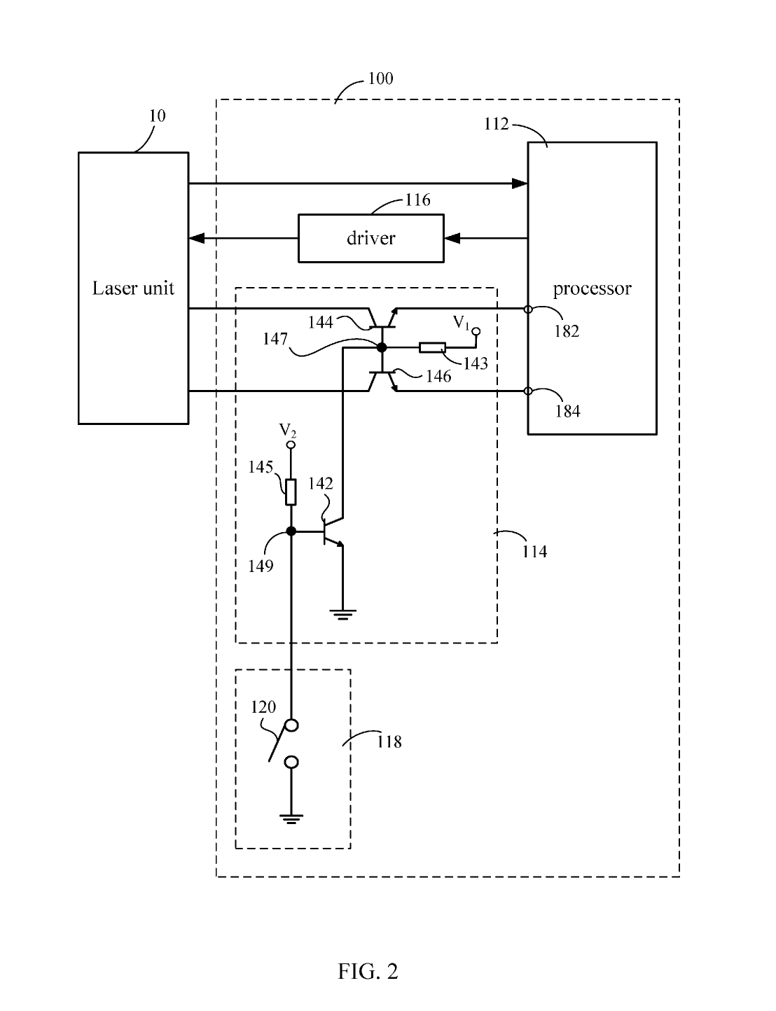

Referring also to FIG. 2, detailed circuits of the switch module 114 and the detector 118 in this embodiment are shown. The processor 112 includes a first contact 182 and a second contact 184 connected to the laser unit 10 via the switch module 114. The first contact 182 is used for transmitting a first emitting command to the laser unit 10, and correspondingly the laser unit 10 emits red lasers for DVD (digital versatile disc). The second contact 184 is used for transmitting a second emitting command to the laser unit 10, and correspondingly the laser unit 10 emits infrared lasers for CD (compact disc).

The switch module 114 includes three bipolar junction transistors (BJT) 142, 144,146, and two resistors 143,145. The emitter of the BJT 144 is connected to the first contact 182 of the processor 112, the collector of the BJT 144 is connected to the laser unit 10, and the base of the BJT 144 is connected to a node 147. The emitter of the BJT 146 is connected to a second contact 184 of the processor 112, the collector of the BJT 146 is connected to the laser unit 10, and the base of the BJT 146 is connected to the node 147. Therefore, the BJTs 144, 146 function as two electronic switches correspondingly for controlling a first electrical connection between the laser unit 10 and the first contact 182 and a second electrical connection between the laser unit 10 and the second contact 184.

One end of the resistor 143 is connected to the node 147, and the other end of the resistor 143 is connected to a first power source V1. The resistor 143 is used for transmitting a first power from the first power source V1 to the node 147. The node 147 is connected to the collector of the BJT 142. The emitter of the BJT 142 is connected to ground, and the base of the BJT 142 is connected to a node 149. The BJT 142 also functions as an electrical switch that controls a voltage of the node 147.

One end of the resistor 145 is connected to the node 149, and the other end of the resistor 145 is connected to a second power source V2. The resistor 145 is used for transmitting a second power from the second power source V2 to the node 149. The node 149 is connected to the detector 118.

The detector 118 includes a single-pole single-throw (SPST) switch 120. One end of the SPST switch 120 is connected to the node 149, and the other end of the SPST switch 120 is connected to ground. The SPST switch 120 is used for controlling a voltage of the node 149. In the embodiment, the SPST switch 120 is disposed adjacent to the tray of the DVD player.

A detailed description is given as follows to introduce a principle of the laser control apparatus 100. Only one of the first contact 182 and the second contact 184 is activated at any one time by the processor 112 according to a type of the optical disc, ie, CD or DVD, loaded in the DVD player. Take the DVD as an example, the first contact 182 is activated with a low level voltage while the second contact 184 is held with a high level voltage. When the cover 20 is closed, the SPST switch 120 is closed, and the node 149 is pulled down lower than the turn-on voltage for the BJT 142. Therefore, the BJT 142 is turned off. The node 147 receives a high level voltage from the first power source V1 via the resister 143. Consequently, the BJT 144 is turned on while the BJT 146 is turned off. The first electrical connection is closed, but the second electrical connection is opened. The laser unit 10 receives the first emitting command to emit the red lasers.

When the cover 20 is opened, the SPST switch 120 is turned off. The node 149 receives a high level voltage from the second power source V2 via the resister 145. The first BJT 142 is turned on, thus the node 147 is pulled down lower than the turn-on voltage for the BJTs 144 and 146. Consequently, the BJTs 144, 146 are turned off, and the first and the second electrical connections are opened. Therefore, the laser unit 10 stops emitting lasers.

As mentioned above, in the embodiment, the laser control apparatus 100 utilizes the detector 118, to detect the closed state and the opened state of the cover 20 of the DVD player, and the switch module 114, to control the laser unit 10, to emit lasers. Therefore, whenever the cover 20 is opened, the laser unit 10 stops emitting the lasers immediately. In other embodiments, the cover 20 of the DVD player can be replaced with other mechanisms of other electronic devices, such as a lid of a laser printer, to establish a detecting relationship with the detector 118.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A laser control apparatus comprising:
a detector for detecting states of a mechanism having a closed state in which the mechanism blocks a laser and an opened state in which the mechanism unblocks the laser;
a switch module for transmitting an emitting command to a laser unit to emit the laser; and
wherein the switch module stops transmitting the emitting command if the opened state is detected.

2. The laser control apparatus according to claim 1, wherein the detector comprises a switch, and when the mechanism is in the closed state the switch is turned on, and when the mechanism is in the opened state the switch is turned off.

3. The laser control apparatus according to claim 2, wherein the switch module comprises a first BJT, and the emitter of the first BJT is for receiving the emitting command, and the collector of the first BJT is for transmitting an emitting command to a laser unit, and the base is under the control of the switch.

4. The laser control apparatus according to claim 3, wherein the base of the first BJTis connected to a first power source via a first resistor.

5. The laser control apparatus according to claim 4, wherein the switch module comprises a second BJT, and the collector of the second BJT is connected to the base of the first BJT, and the emitter of the second BJT is connected to ground, and the base of the second BJT is connected to the switch.

6. The laser control apparatus according to claim 5, wherein the base of the second BJT is connected to a second power source via a second resistor.

7. The laser control apparatus according to claim 5, wherein one end of the switch is connected to the base of the second BJT, and the other end of the switch is connected to ground.

8. An electronic device comprising:
a mechanism having a closed state in which the mechanism blocks lasers and an opend state in which the mechanism unblocks the lasers;
a processor for generating emitting commands;
a laser unit for receiving the emitting commands and emitting the lasers correspondingly;
a detector for detecting the closed state and the opened state of the mechanism;
a switch module for controlling an electrical connection between the laser unit and the processor; and
wherein the switch module opens the electrical connection if the opened state is detected.

9. The electronic device according to claim 8, wherein the detector comprises a switch, and when the mechanism is in the closed state the switch is turned on, and when the mechanism is in the opened state the switch is turned off.

10. The electronic device according to claim 9, wherein the switch module comprises a first BJT, and the emitter of the first BJT is connected to the processor, and the collector of the first BJT is connected to a laser unit, and the base is under the control of the switch.

11. The electronic device according to claim 10, wherein the base of the first BJT is connected to a first power source via a first resistor.

12. The electronic device according to claim 11, wherein the switch module comprises a second BJT, and the collector of the second BJT is connected to the base of the first BJT, and the emitter of the second BJT is connected to ground, and the base of the second BJT is connected to the switch.

13. The electronic device according to claim 12, wherein the base of the second BJT is connected to a second power source via a second resistor.

14. The electronic device apparatus according to claim 12, wherein one end of the switch is connected to the base of the second BJT, and the other end of the switch is connected to ground.
